(19) United States
(12) Patent Application Publication
(10) Pub. No.: US 2026/0125126 A1
(43) Pub. Date: May 7, 2026

(54) Adjustable Height Vehicle Trailer

(71) Applicant: Daniel Zierden, Fergus Falls, MN (US)

(72) Inventor: Daniel Zierden, Fergus Falls, MN (US)

(21) Appl. No.: 18/940,310

(22) Filed: Nov. 7, 2024

(51) Int. Cl. B62D 63/06

(52) U.S. Cl. CPC B62D 63/061

(57) ABSTRACT

An adjustable height vehicle trailer includes a flatbed attachable to a vehicle, a cover assembly, a door assembly, and a lifting assembly. The cover assembly is designed to cover items transported on the flatbed and includes a top panel, a front panel, a pair of side panels. The pair of side panels and the front panel each includes an upper section attached to the top panel and a lower section attached to the flatbed. The door assembly is retractably mounted to a rear portion of the top panel to cover a rear opening in the cover assembly. The lifting assembly is mounted on the flatbed and supports the top panel. The lifting assembly is designed to selectively move the top panel up and down to extend and collapse the side panels and the front panel and move the upper section into an overlapping position with respect to the lower section.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to vehicle trailers and more particularly pertains to a new adjustable height vehicle trailer for use with tractor trailers, cars, trucks, and box trucks with permanent trailers. The adjustable height vehicle trailer can be adjusted to be taller or shorter based on the total or highest height of the items carried on the flatbed of the trailer in order to improve reduce drag and wind resistance and thereby improve aerodynamics and fuel consumption and efficiency. Hard-walled trailers, such as tractor trailers, box truck trailers, and automobile trailers are not adjustable in height due to the hard walls made of metal or hard plastic or reinforced plastic like fiberglass, whereas the adjustable height vehicle trailer is adjustable as disclosed herein.

### (2) Description of Related Art Including Information Disclosed Under 37 CFR 1.97 and 1.98

The prior art relates to vehicle trailers that have air deflector pieces and devices that are added onto the trailer body for better aerodynamics, but do not disclose a vehicle trailer that can be made shorter in height to improve aerodynamics. The prior art, as best understood, does not disclose an adjustable height vehicle trailer that includes a flatbed attachable to a vehicle, a cover assembly, a door assembly, and a lifting assembly, wherein the lifting assembly is mounted on the flatbed and supports a top panel of the cover assembly, and wherein the lifting assembly is designed to selectively move the top panel up and down to extend and collapse side panels and a front panel of the cover assembly and move an upper section of each of the side panels and the front panel into an overlapping position with respect to a lower section of each.

### BRIEF SUMMARY OF THE INVENTION

An embodiment of the disclosure meets the needs presented above in an adjustable height vehicle trailer generally comprising a flatbed attachable to a vehicle, a cover assembly, a door assembly, and a lifting assembly. The cover assembly is designed to cover items being transported on the flatbed and includes a top panel, a front panel, a pair of side panels, wherein the pair of side panels and the front panel each includes an upper section attached to the top panel and a lower section attached to the flatbed. The door assembly is retractably mounted to a rear portion of the top panel to cover a rear opening in the cover assembly. The lifting assembly is mounted on the flatbed and supports the top panel, wherein the lifting assembly is designed to selectively move the top panel up and down to extend and collapse the side panels and the front panel and move the upper section into an overlapping position with respect to the lower section.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side view of an adjustable height vehicle trailer according to an embodiment of the disclosure.

FIG. 2 is a side view of an embodiment of the disclosure.

FIG. 3 is a side view of an embodiment of the disclosure.

FIG. 4 is a side view of an embodiment of the disclosure.

FIG. 5 is a side view of an embodiment of the disclosure.

FIG. 6 is a side view of an embodiment of the disclosure.

FIG. 7 is a side cross-sectional view of an embodiment of the disclosure.

FIG. 8 is a rear perspective view of an embodiment of the disclosure.

FIG. 9 is a rear perspective view of an embodiment of the disclosure.

FIG. 10 is a rear perspective view of an embodiment of the disclosure.

FIG. 11 is a rear view of an embodiment of the disclosure.

FIG. 12 is a rear view of an embodiment of the disclosure.

FIG. 13 is a side cross-sectional view of an embodiment of the disclosure.

FIG. 14 is a top cross-sectional view of an embodiment of the disclosure.

FIG. 15 is a rear view of an alternative embodiment of the disclosure.

FIG. 16 is a rear view of the alternative embodiment of the disclosure.

### DETAILED DESCRIPTION OF THE INVENTION

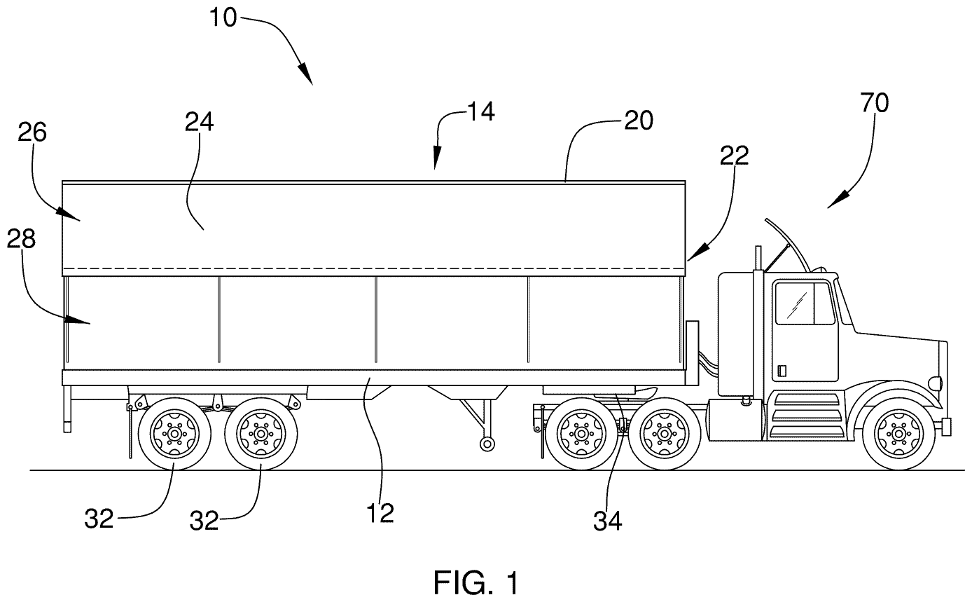

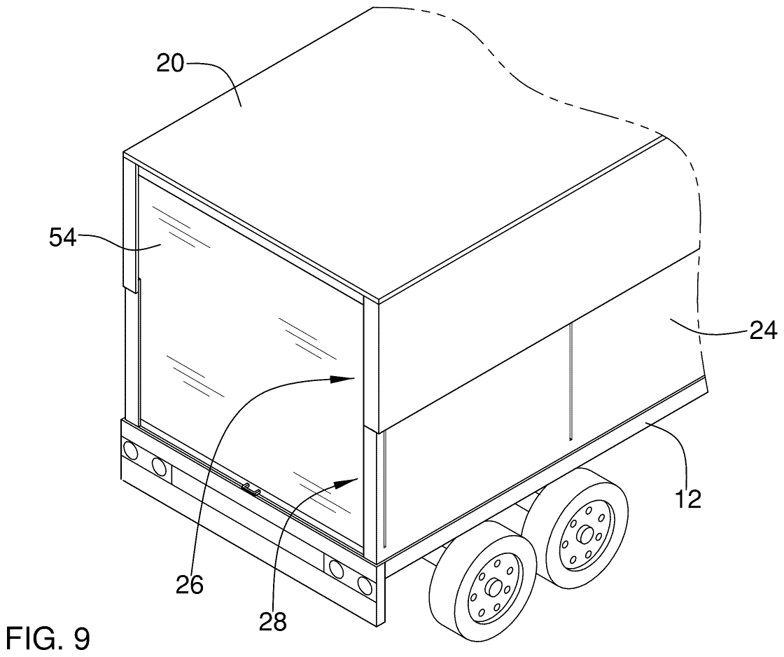

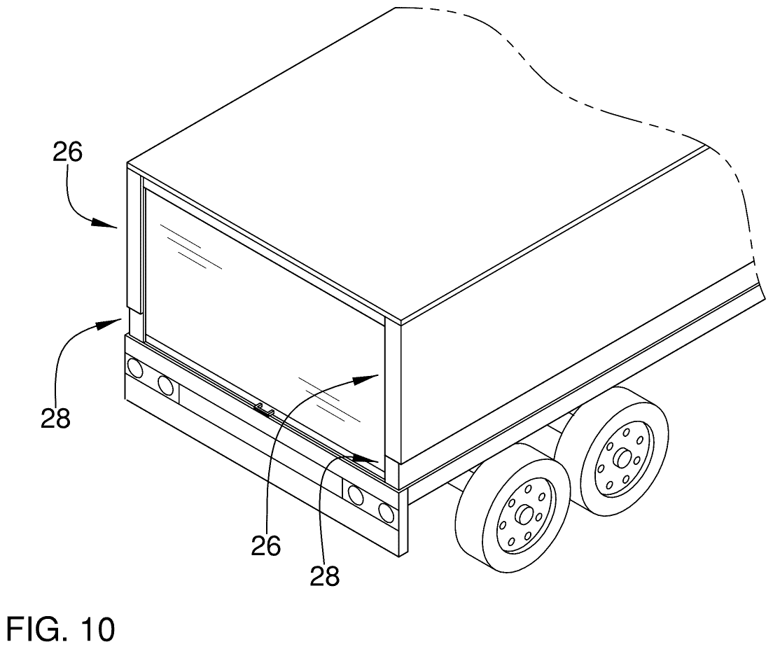

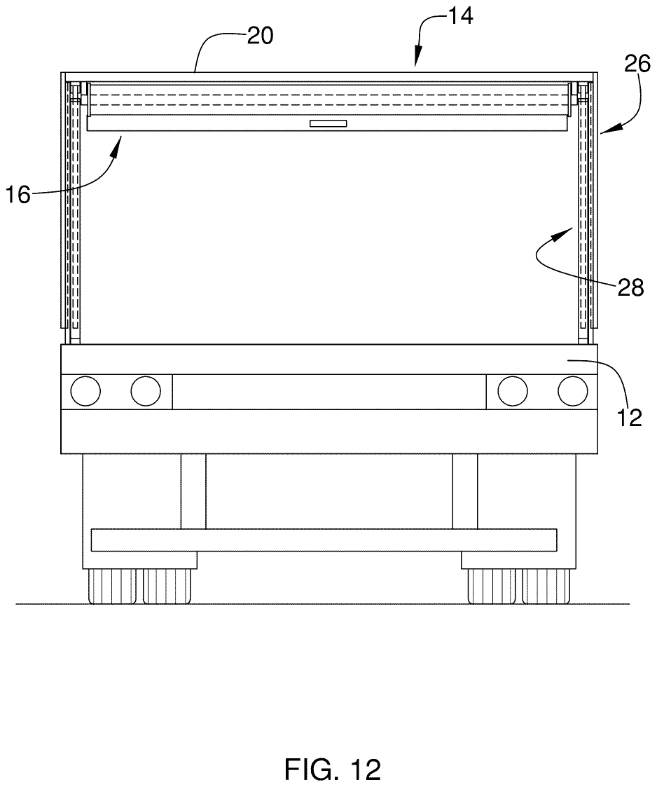

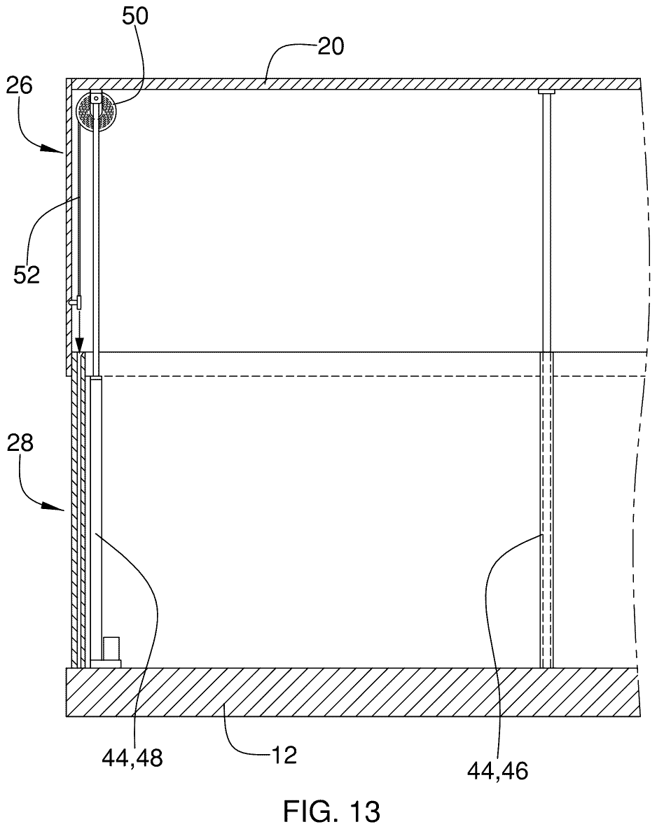

With reference now to the drawings, and in particular to FIGS. 1 through 16 thereof, a new adjustable height vehicle trailer embodying the principles and concepts of an embodiment of the disclosure and generally designated by the reference numeral 10 will be described.

As best illustrated in FIGS. 1 through 16, the adjustable height vehicle trailer 10 generally comprises a flatbed 12 attachable to a vehicle, a cover assembly 14, a door assembly 16, and a lifting assembly 18. The cover assembly 14 is designed to cover items being transported on the flatbed 12 and includes a top panel 20, a front panel 22, a pair of side panels 24, wherein the pair of side panels 24 and the front panel 22 each includes an upper section 26 attached to the top panel 20 and a lower section 28 attached to the flatbed 12. The door assembly 16 is retractably mounted to a rear portion of the top panel 20 to cover a rear opening 30 in the cover assembly 14. The lifting assembly 18 is mounted on the flatbed 12 and supports the top panel 20, wherein the lifting assembly 18 is designed to selectively move the top panel 20 up and down to extend and collapse the side panels 24 and the front panel 22 and move the upper section 26 into an overlapping position with respect to the lower section 28. It should be noted that numbers for duplicate components may be omitted from some drawings where unnecessary for understanding of what is disclosed.

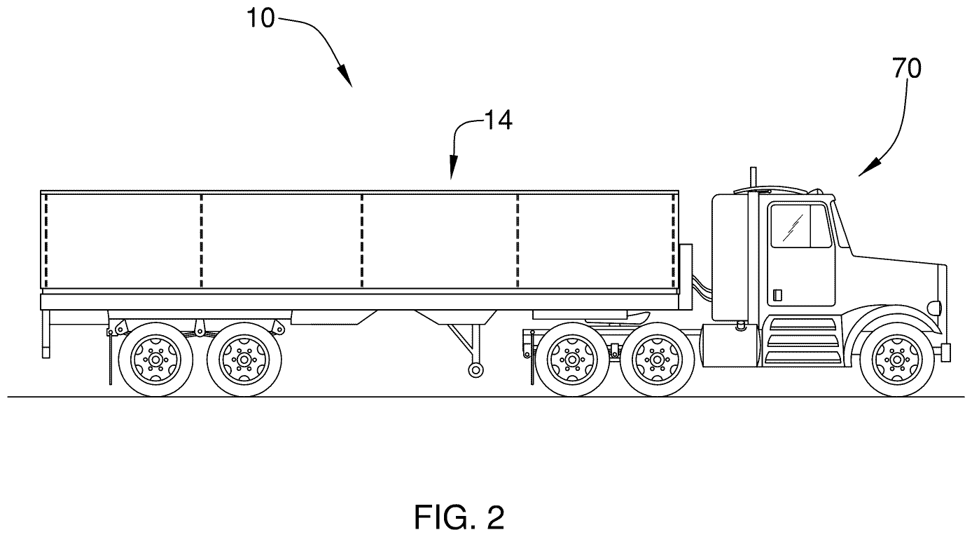

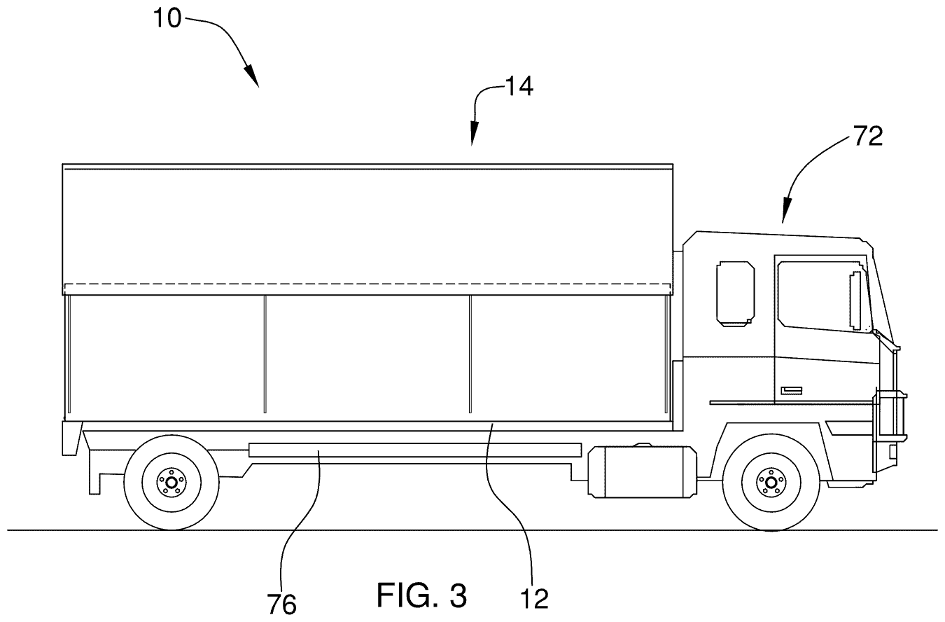

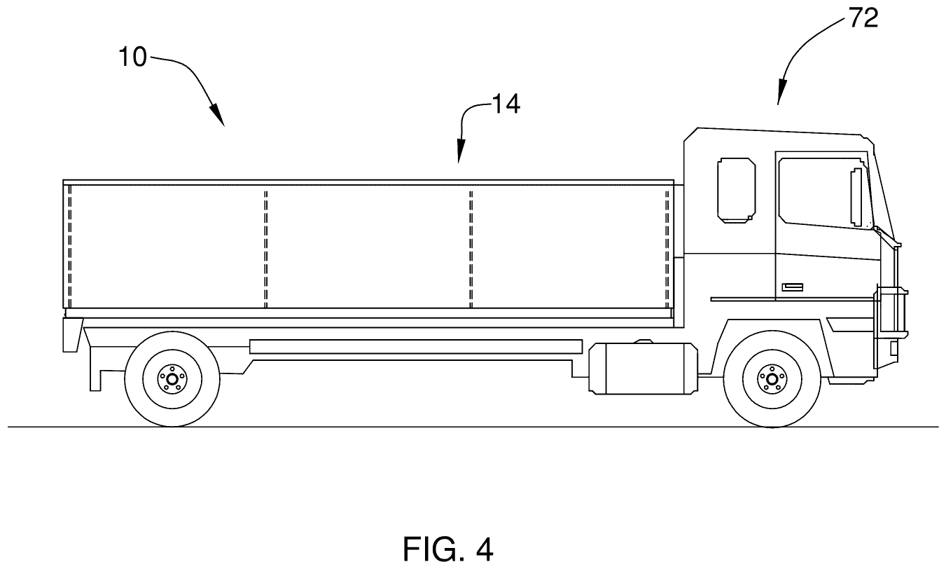

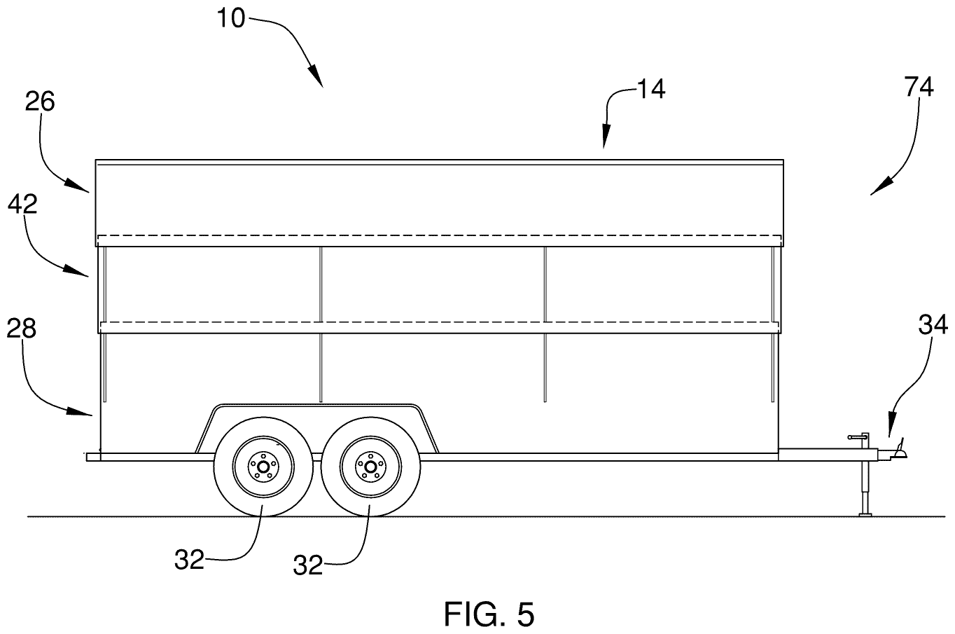

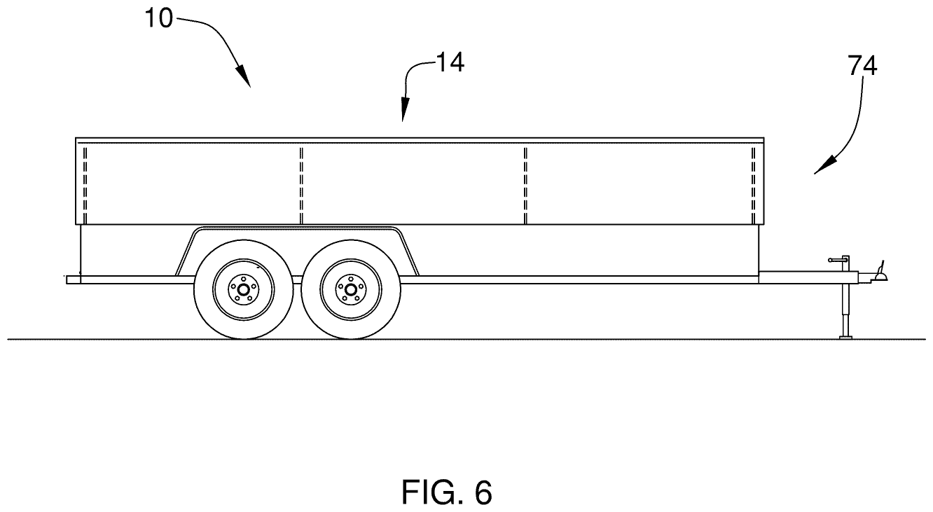

The adjustable height vehicle trailer 10 is primarily for use with commercial vehicles that are used routinely for commercial deliveries, often over substantial distances, such as a trailer for a semi-truck or tractor trailer 70, as shown in FIGS. 1 and 2, or as a permanently attached trailer portion of a box truck 72, moving truck, or similar, as shown in FIGS. 3 and 4. However, the adjustable height vehicle trailer 10 can also be used with private or commercial automobiles in the form of a tow trailer 74, such as shown in FIGS. 5 and 6. In the case of semi-trucks 70 and tow trailers 74 for automobiles, the flatbed 12 includes wheels 32 and a pivotable connection 34 to connect the flatbed 12 to a tow portion of an automobile or semi-truck. In the case of a box truck 72, the flatbed 12 is permanently attached to or mounted on a wheeled support frame 76 extending from the truck portion. The various designs, components, and functions of the possible embodiments of the adjustable height vehicle trailer 10 are equally applicable for each of the different vehicle types.

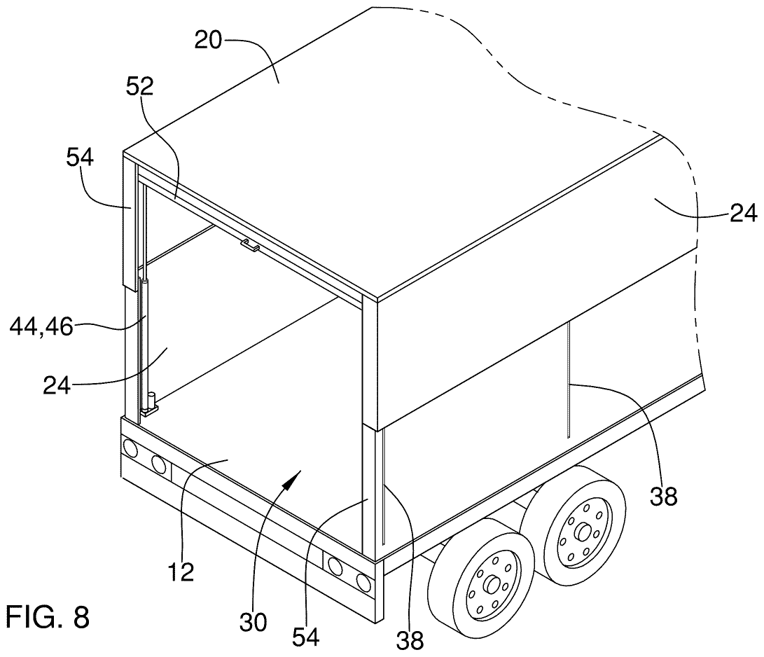

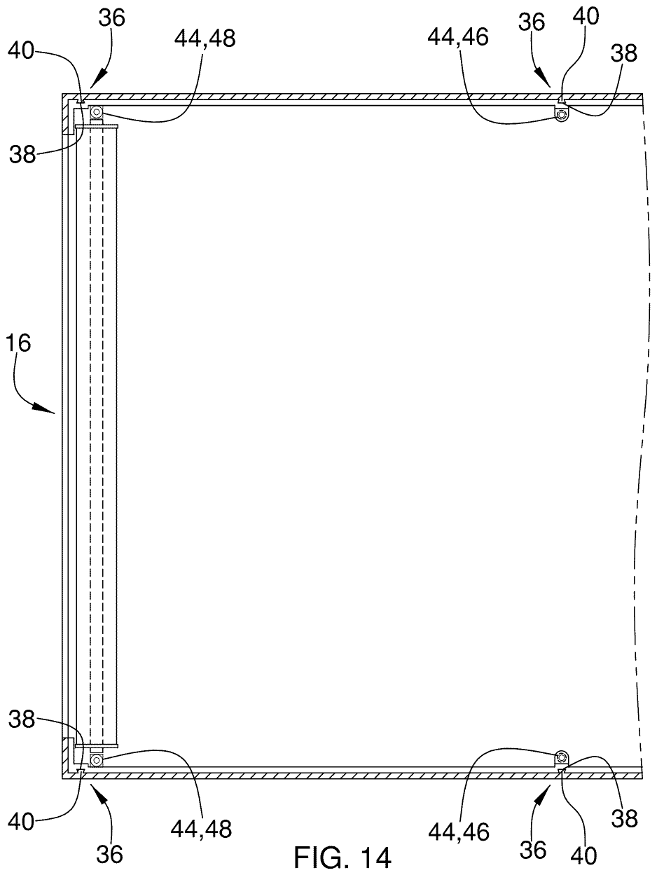

In the embodiments shown in FIGS. 1 through 14, each of the top panel 20, the front panel 22, and the pair of side panels 24 is made of metal or hard plastic, and the upper section 26 and the lower section 28 are arranged in a telescoping manner. In other words, the panels are hard or solid panels made of such hard material, which could be, for example, steel, aluminum, fiberglass, polymers, or a combination thereof. In the exemplary embodiments shown, the upper section 26 is designed to fit over the lower section 28 in a telescoping manner, though it is possible for the upper section 26 to be designed to fit inside the lower section 28. The particulars of the telescoping design can be most any design known within the lifting arts. For example, in the exemplary embodiments shown, the upper section 26 and the lower section 28 together include a guide track assembly 36 to guide relative movement of the upper section 26 with respect to the lower section 28. As best seen in FIG. 8, the guide track assembly 36 includes guide tracks 38 formed in the lower section 28. As best seen in FIG. 14, corresponding guide projections 40 are formed in the upper section 26. The guide track assembly 36 assists in guiding the upper section 26 and the lower section 28 when moved relative to one another. In addition, in another possible embodiment shown in FIG. 5, the pair of side panels 24 and the front panel 22 each further includes at least one middle section 42 positioned in a telescoping manner between the upper section 26 and the lower section 28. Such a design is useful when there are fixed adjustment options, wherein each section is individually collapsible and extendable to permit three different height options for a user, as is well known in the lifting arts.

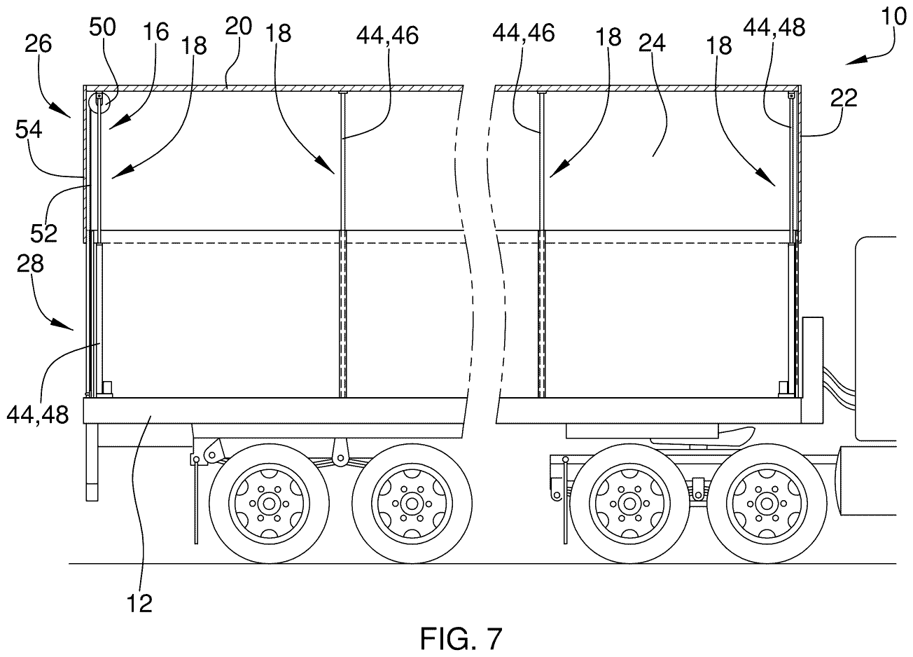

As best seen in FIG. 7, the lifting assembly 18 includes a plurality of lifting units 44. In one possible embodiment, each of the lifting units 44 includes a pneumatic or hydraulic piston or includes an electric drive and spindle. Such lifting units 44 could be considered powered lifting units 44 that are selectively operable by a user using a control unit or interface (not shown) as is well known in the lifting arts. In the exemplary embodiment shown in FIG. 7, there are four lifting units 44 shown on one side of the adjustable height vehicle trailer 10, wherein the inner two lifting units 44 are unpowered telescoping support posts 46, and the outer two lifting units 44 are powered lifting units 48, such as pneumatic, hydraulic, or electric. The other side of the adjustable height vehicle trailer 10 has a matching design, shown partially in FIG. 14, such that there are four powered lifting units 48, one each positioned adjacent and connected to a corresponding corner portion of the top panel 20. There are also four support posts 46. As noted above, the adjustments in height could be one of a number of fixed or set heights, or the adjustments could be completely selectable between a fully extended state and a fully collapsed state, which cannot be lower than the height of the lower section 28.

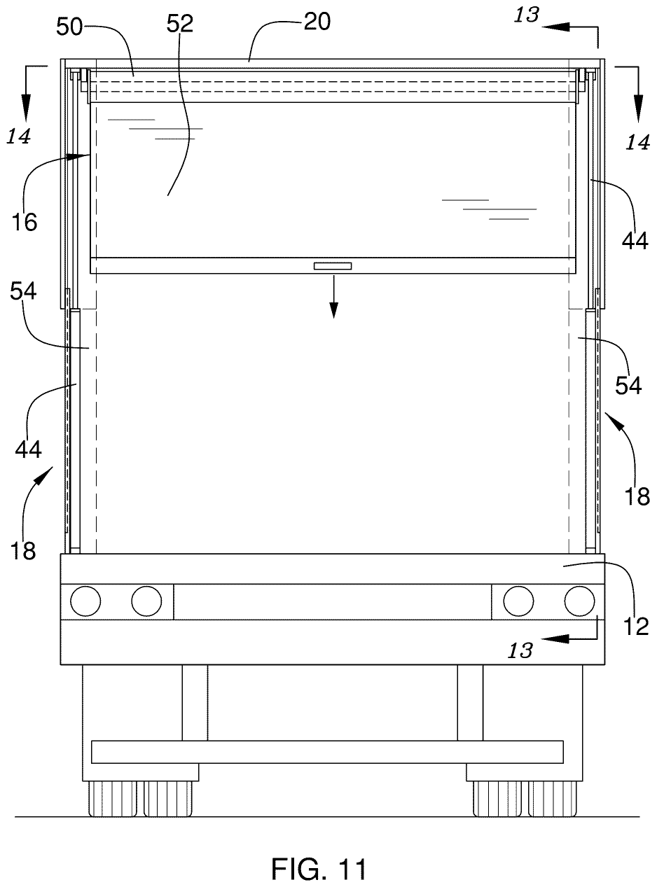

As best shown in FIG. 11, the door assembly 16 includes a spring-loaded spool 50 and a flexible door panel 52 designed to be extended from the top panel 20 to the flatbed 12. The flexible door panel 52 could be formed from a durable flexible material, such as a plastic or cloth or canvas, or possibly a series of interconnected metal strips or sections. In addition, there can be rear door panels 54 or strips that are attached to the edges of the side panels 24. However, this is an exemplary embodiment, and different types of door assemblies could be utilized provided they are retractable in whole or in part to permit adjustment of the height of the cover assembly 14.

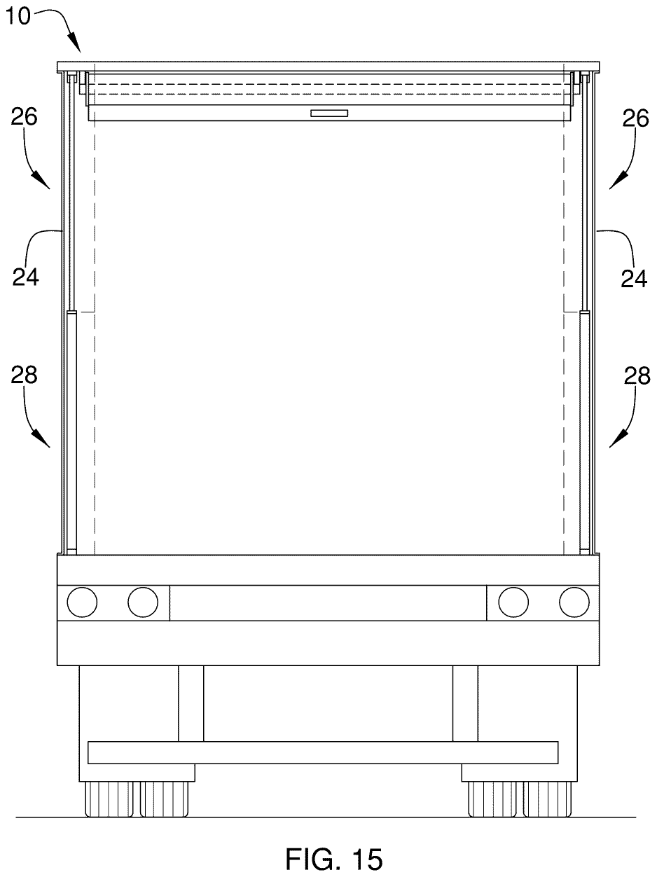

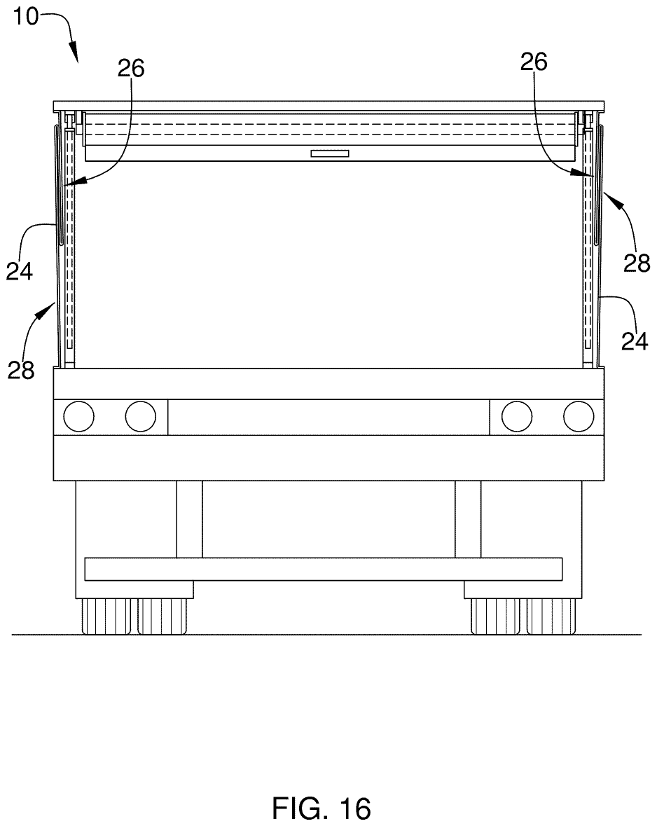

FIGS. 15 and 16 show an alternative design for the cover assembly 14 in which each of the front panel 22 (not shown) and the pair of side panels 24 is made of a flexible material, in whole or in part, instead of being made from a hard material as in FIGS. 1 through 14. For example, the flexible material could be plastic, canvas, textiles, elastomers, or other such flexible material that is durable and weather-resistant. Instead of being arranged in a telescoping manner, the upper section 26 and the lower section 28 can be folded over one another, such as shown in FIG. 16. In one possible embodiment, a skeletal frame (not shown) could be included to reinforce the flexible material and possibly guide or control the folding action. In one possible embodiment, the flexible material could be folded up like an accordion or sleeve over a frame section.

For all designs of the adjustable height vehicle trailer 10, the operation is the same. A user places articles on the flatbed 12 inside the cover assembly 14, which is presumably at full height or extension, such as shown in FIGS. 1, 3, 5, and 9, to permit full access to the user, though the user could also place articles inside the cover assembly 14 when at a reduced height or partially or fully collapsed state, such as shown in FIGS. 2, 4, 6, and 10. When done placing articles, the user can operate the lifting assembly 18 to lower the top panel 20 and thus adjust the height of the cover assembly 14 to match or be close to the height of the tallest article or stack of articles. The user can then drive the corresponding vehicle to which the adjustable height vehicle trailer 10 is detachably or permanently connected to another location, whether the cover assembly 14 is at full height or at least partially collapsed to a lower height, wherein the lower height would help lower wind resistance and therefore improve aerodynamics and increase fuel efficiency.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An adjustable height vehicle trailer comprising:
a flatbed;
a cover assembly being mounted on said flatbed, said cover assembly including a top panel, a front panel, and a pair of side panels, each of said pair of side panels and said front panel including an upper section attached to said top panel and a lower section attached to said flatbed;
a door assembly being retractably mounted to a rear portion of said top panel to cover a rear opening in said cover assembly; and
a lifting assembly being mounted on said flatbed and coupled to said top panel, said lifting assembly being configured to selectively move said top panel up and down to extend and collapse said side panels and said front panel and move said upper section into an overlapping position with respect to said lower section.

2. The adjustable height vehicle trailer of claim 1, wherein each of said top panel, said front panel, and said pair of side panels comprises metal or hard plastic, and said upper section and said lower section are arranged in a telescoping manner.

3. The adjustable height vehicle trailer of claim 2, wherein said pair of side panels and said front panel each further comprises at least one middle section disposed in a telescoping manner between said upper section and said lower section.

4. The adjustable height vehicle trailer of claim 2, wherein said upper section is configured to fit over said lower section.

5. The adjustable height vehicle trailer of claim 2, wherein said upper section and said lower section comprise a guide track assembly to guide relative movement of said upper section with respect to said lower section.

6. The adjustable height vehicle trailer of claim 1, wherein each of said front panel and said pair of side panels comprises a flexible material.

7. The adjustable height vehicle trailer of claim 1, wherein said flatbed comprises wheels and a pivotable connection to connect said flatbed to a tow portion of an automobile or semi-truck.

8. The adjustable height vehicle trailer of claim 1, wherein said door assembly comprises a spring-loaded spool and a flexible door panel configured to be extended from said top panel to said flatbed.

9. The adjustable height vehicle trailer of claim 1, wherein said lifting assembly comprises a plurality of lifting units.

10. The adjustable height vehicle trailer of claim 9, wherein each of four of said plurality of lifting units is disposed adjacent and connected to a corresponding corner portion of said top panel.

11. The adjustable height vehicle trailer of claim 9, wherein each of said lifting units comprises a pneumatic or hydraulic piston.

12. The adjustable height vehicle trailer of claim 9, wherein each of said lifting rods comprises an electric drive and spindle.

13. An adjustable height vehicle trailer comprising:
a flatbed including wheels and a pivotable connection to connect said flatbed to a tow portion of an automobile or semi-truck;
a cover assembly being mounted on said flatbed, said cover assembly including a top panel, a front panel, and a pair of side panels, each of said pair of side panels and said front panel including an upper section attached to said top panel and a lower section attached to said flatbed;
a door assembly being retractably mounted to a rear portion of said top panel to cover a rear opening in said cover assembly, said door assembly including a spring-loaded spool and a flexible door panel configured to be extended from said top panel to said flatbed; and
a lifting assembly being mounted on said flatbed and coupled to said top panel, said lifting assembly being configured to selectively move said top panel up and down to extend and collapse said side panels and said front panel and move said upper section into an overlapping position with respect to said lower section, said lifting assembly including a plurality of lifting units, wherein four of said lifting units are disposed adjacent and connected to a respective corner portion of said top panel, each of said lifting units including one of: a pneumatic piston, a hydraulic piston, or an electric drive and spindle.

14. The adjustable height vehicle trailer of claim 13, wherein each of said top panel, said front panel, and said pair of side panels comprises metal or hard plastic, and said upper section and said lower section are arranged in a telescoping manner.

15. The adjustable height vehicle trailer of claim 14, wherein said pair of side panels and said front panel each further comprises at least one middle section disposed in a telescoping manner between said upper section and said lower section.

16. The adjustable height vehicle trailer of claim 15, wherein said upper section is configured to fit over said lower section.

17. The adjustable height vehicle trailer of claim 16, wherein said upper section and said lower section comprise a guide track assembly to guide relative movement of said upper section with respect to said lower section.

18. The adjustable height vehicle trailer of claim 13, wherein each of said front panel and said pair of side panels comprises a flexible material.
